(19) United States
(12) Patent Application Publication
(10) Pub. No.: US 2004/0009730 A1
(43) Pub. Date: Jan. 15, 2004

(54) High elastic and anti-velco wet suit fabric

(76) Inventor: Chi Chou Chuang, Dong Shan shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/191,560

(22) Filed: Jul. 10, 2002

(51) Int. Cl. B32B 25/10

(52) U.S. Cl. 442/308; 442/304; 442/315; 442/37

(57) ABSTRACT

The present invention is a high elastic and anti-velco wet suit fabric made of fine count high twist artificial yarns with fine denier counts. The texture of the present invention is designed on the basis of elastic features, woven with a high-speed circular knitting machine and processed in a treatment process. Such high elastic and anti-velco wet suit fabric is then laminated with an artificial rubber sponge in a laminating process to form a high elastic and anti-velco wet suit fabric piece. The high elastic wet suit fabric of the present invention has a high elasticity, low modulus, more easily dried and high anti-velco capability in comparison with conventional single-directional and low-elastic wet suit fabric, and is capable to improve the comfort, flexibility and elongation of wet suits.

### BACKGROUND OF THE INVENTION

The present invention relates to a wet suit fabric, more particularly to a high elastic and anti-velco fabric used for the production of wet suits with higher elasticity, anti-velco, easily drying features and comfort. The present invention is capable to improve the quality of wet suit and related products.

Traditionally, the fabric piece used for the production of wet suits is a one-sided knitted cloth made of 100% nylon and laminated with an artificial rubber sponge. However, since wet suits must be a good fit, the conventional wet suits made of the aforementioned fabric piece, that has only single-directional low elasticity, restricts the movement of each joint of a human body. In addition, since each part of the human body is different, the constraint needed for individual parts of the human body is variable. However, the conventional wet suits are not capable to meet this demand and make wearers uncomfortable due to poor fit of such wet suits. On the other hand, the knitted cloth traditionally used to produce wet suits is poor in anti-velco, so the fabric easily suffers pilling. The present invention provides a high elastic and anti-velco wet suit fabric to improve the aforementioned disadvantages of conventional wet suits.

### SUMMARY OF THE INVENTION

An object of the invention is to provide a high elastic wet suit fabric with better flexibility for each joint of a human body in comparison with conventional wet suit fabric pieces and reduce uncomfortable constraint on individual parts of the human body.

The wet suit fabric of the present invention is made of fine count high twist artificial yarns with fine denier counts and woven with a high-speed circular knitting machine. The yarns are processed to laminate with an artificial rubber sponge and form a fabric piece that is suitable for the production of wet suits and other related products. The wet suit fabric of the present invention is capable to provide an elasticity higher than traditional single-directional low elastic wet suit fabric, reducing the restriction on the movement of each joint of a human body. The wet suits made of such fabric are more fitted, softer and higher anti-velco capability.

The present invention is described in details with the following drawings:

### BRIEF DESCRIPTION OF THE DRAWINGS

FIG. 1 shows a wet suit fabric of the present invention laminated to one single side; and

FIG. 2 shows a wet suit fabric of the present invention laminated to both sides.

### DETAILED DESCRIPTION OF THE INVENTION

The method for the production of the present invention is divided into two processes: manufacturing process of high elastic and anti-velco wet suit fabric and lamination process of artificial rubber sponge.

1. Manufacturing Process of High Elastic Anti-Velco Wet Suit Fabric:

The high elastic and anti-velco wet suit fabric of the present invention is made of fine count high twist artificial yarns with fine denier counts and has a texture designed on the basis of elastic features and anti-velco capability. Such fabric is woven with a high-speed circular knitting machine and formed in further treatment process.

The yarn used in the aforementioned process is made of high twist artificial yarns having a specification below 100 deniers. The high twist fine yarns below 100 deniers are light in weight, have high twist and are capable to reduce absorbency of fabrics.

In the aforementioned process, an interlocking structure is combined in the texture of the fabric. The high twist artificial yarns are fed with each feeder of the loom. The gray cloth of the high elastic and anti-velco wet suit fabric is readjusted to be 150 to 250 g/yd and 54 to 60 inches in the breadth. Such fabric is woven with a loom having a needle range of more than 28 gauges, so as to create a high weaving density, reach the expected elastic level and bring an excellent elongation to laminated finished products. In the weaving process, the high weaving density and tension of the yarns, and the yarn extraction are appropriately controlled. A higher tension of the lower fabric is applied to the loom and low feather counts are used in the process.

After being refined, shaped and otherwise treated in the process, the gray cloth of the high elastic and anti-velco wet suit fabric is readjusted to be 150 to 250 g/yd and 54 to 60 inches in the breadth.

The high elastic and anti-velco fabric 20 of the present invention is produced in the aforementioned process.

2. Lamination Process of Artificial Rubber Sponge:

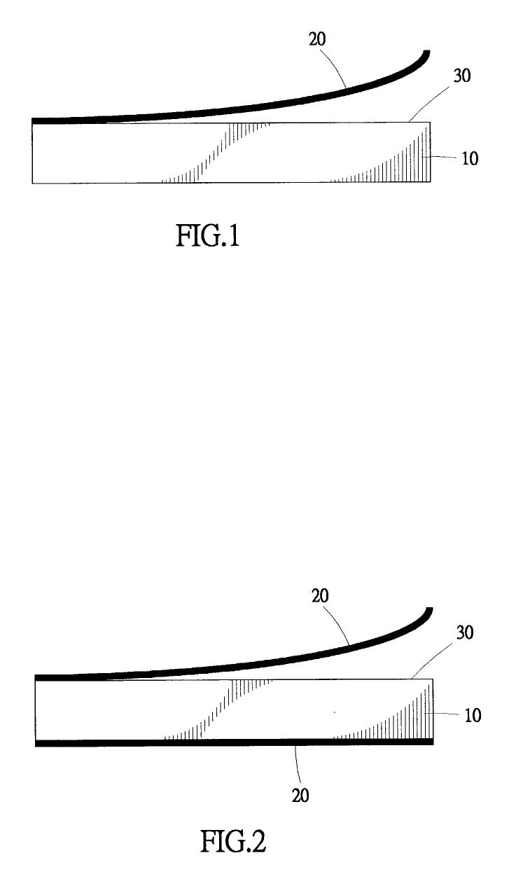

In a lamination process, the polypropylene wet suit fabric of the present invention 20 is laminated with an artificial rubber sponge 10. The thickness of the artificial rubber sponge 10 is variable. As shown in FIGS. 1 and 2, the high elastic and anti-velco fabric is capable to be laminated to one single side and both sides with a blender 30, respectively. The laminated high elastic fabric piece with anti-velco is then made to be a finished high elastic fabric piece with anti-velco at a special elasticity-processing stage.

The differences between the performances of the present invention and the conventional wet suit fabric are shown in attached Table 1, including bursting strength (kgf/c m²), elongation at specified load (%/4.5 kg), tensile breaking strength (kg), 60% elastic modulus (kg/60%), 120 elastic modulus (kg/120%, absorbency (%) and adhesion resistance capability (times).

As shown in Table 1, the present invention is obviously better in performance than the conventional wet suit fabric, especially in the aspects of high elasticity, low modulus, high comfort, easily dried and high anti-velco capability. In the application to professional wet suits, the present invention is more comfortable, flexible durable and fitted for wearers in comparison with conventional wet suit fabrics, and is capable to provide higher value in industrial applications.

Although the substantial functions and uniqueness of the present invention has been illustrated and described with reference to the preferred embodiment thereof, it should be under stood that it is in no way limited to the details of such embodiment but is capable of numerous modifications within the scope of the appended claims.

TABLE 1
Performance Comparison List

| | | | Conventional | The present | |
|---|---|---|---|---|---|
| Test Item | Direction | | wet suit fabric | invention | Tester |
| Bursting | # N/A | | 10 | 19 | Mullen bursting |
| Strength | | | | | strength tester |
| (kgf/cm²) | | | | | (15 × 15 cm/PC) |
| Elongation at | WARP | 90 | 90 | 180 ↑ | CRE/Grab |
| specified load | | | | | method (fabric |
| (%/4.5 kg) | WEFT | 140 | 140 | 180 ↑ | & fabric |
| | | | | | piece/clamp |
| | | | | | width 1″) |

| | | | | |
|---|---|---|---|---|
| Tensile breaking | WARP | 28 | 25 | CRE/Strip |
| strength (kg) | WEFT | 21 | 31 | method |
| 60% elastic | WARP | 1.7 | 0.37 | CRE/Strip |
| modulus | WEFT | 0.9 | 0.30 | method (2.54 × |
| (kg/60%) | | | | 12 cm/PC) |
| 120% elastic | WARP | — | 0.58 | CRE/Strip |
| modulus | WEFT | 2.6 | 0.60 | method (2.54 × |
| (kg/120%) | | | | 12 cm/PC) |
| Absorbency | # N/A | 100% | 67% | Comparative |
| (Nylon = 100%) | | | | test (10 × |
| | | | | 10 cm/PC) |
| Anti-Velco | # N/A | 0 | 50 times ↑ | Velco 10 × |
| (times) | | | | 10 cm |

What is claimed is:

1. A high elastic and anti-velco wet suit fabric formed by laminating a high elastic fabric piece with anti-velco with an artificial rubber sponge, wherein:
said A high elastic and anti-velco wet suit fabric is made of various fine count high twist artificial yarns, has a texture designed on the basis of elastic features, is woven with a high-speed circular knitting machine and formed in a treatment process; said high elastic and anti-velco wet suit fabric has a specification below 100 deniers, an interlocking texture design, a gray cloth being readjusted to be 150 to 250 g/yd and 54 to 60 inches in breadth; after being refined, shaped and otherwise treated in the process, said gray cloth of the high elastic and anti-velco wet suit fabric is readjusted to be 150 to 250 g/yd and 54 to 60 inches in the breadth, forming a finished high elastic and anti-velco wet suit fabric;
said high elastic and anti-velco wet suit fabric is laminated with artificial rubber sponges with various thickness; a blender is applied to a laminating surface of said high elastic and anti-velco wet suit fabric; said laminated high elastic and anti-velco wet suit fabric piece is than treated at a special elasticity-processing stage to form a finished high elastic and anti-velco wet suit fabric piece.

2. The high elastic wet suit fabric as claimed in claim 1, wherein the artificial rubber sponge is laminated on one single side with said high elastic and anti-velco wet suit fabric in the laminating process.

3. The elastic polypropylene wet suit fabric as claimed in claim 1, wherein the artificial rubber sponge is laminated on both front and reverse sides with said high elastic and anti-velco wet suit fabric in said laminating process.
